(19) United States
(12) Patent Application Publication
(10) Pub. No.: US 2007/0112962 A1
(43) Pub. Date: May 17, 2007

(54) Network connection establishment using out of band connection request

(76) Inventor: Steve Lewontin, Cambridge, MA (US)

Correspondence Address: Hollingsworth & Funk, LLC, Suite 125, 8009 34th Avenue South, Minneapolis, MN, 55425, US

(21) Appl. No.: 11/274,748

(22) Filed: Nov. 14, 2005

(51) Int. Cl. G06F 15/16

(52) U.S. Cl. 709/227

(57) ABSTRACT

A data connection between a client and a server via a primary network path where the client is unable to establish the data connection to the server using established procedures of the primary network path. A connection request message is formed that substitutes for a connection request of the primary network path. The connection request message is sent to the server via a secondary data path that is separate from the primary network path. The data connection is then established between the server and the client via the primary network path based on receipt of the connection request message via the secondary data path.

### FIELD OF THE INVENTION

This invention relates in general to communications networks, and more particularly to providing data connections to network-coupled mobile devices.

### BACKGROUND OF THE INVENTION

Mobile communications devices such as cell phones are gaining wide acceptance. The popularity of these devices is due their portability as well as the advanced features being added to such devices. Modem cell phones and related devices offer an ever-growing list of digital capabilities. For example, many phones may be equipped with server software that allows the devices to provide customized network services.

In the client-server model of computing, a server is a computer that listens for incoming network connections, and a client is a device that initiates those connections. In some applications, such as network file systems, devices may act as both client and server. In order for a server to provide a network service on a Transmission Control Protocol/Internet Protocol (TCP/IP) network, a server process listens on a predetermined TCP port. Some TCP ports are commonly associated with specific services, such as port 23 with telnet and port 80 with the Hypertext Transport Protocol (HTTP).

When a client wishes to connect to a server via TCP/IP, the client initiates what is known as a “three-way handshake” to establish a TCP connection. The handshake begins by the client sending what is known as a SYN packet/segment to an IP address of the server. The server process detects these connection requests, and provides an acknowledgment to the client. The acknowledgement also establishes some state variables used in the transaction. The client also acknowledges, and thereafter the client and server can exchange data over a full-duplex TCP/IP connection.

One problem in using mobile devices as TCP/IP servers is that, depending on their location, mobile devices may not be IP addressable. Such devices are typically located on a network that lies behind a Network Address Translation (NAT) firewall maintained by the mobile operator or other network provider. A NAT firewall may not always assign an external IP address to the device until the device makes an outgoing connection request. The firewall then dynamically assigns a short-lived external IP address. The firewall also typically prevents incoming TCP connection requests on this address by blocking the SYN packets required to initiate the TCP connection establishment handshake.

This network configuration effectively prevents the mobile device from hosting services such as location, user profile, device configuration, message queues, etc., via the normal TCP/IP mechanisms. For example, the device cannot deploy a Web server since the server must listen on an externally addressable TCP port in order to be accessed by clients.

Prior solutions to this problem worked at the application level. For example, the device might host an application that makes periodic outgoing connection requests (“polling”) to a gateway or other server in the network. If there is an incoming request for the terminal it is contained in the response to the outgoing polling request. This mechanism is used, for example, by the JXTA protocol.

Because these prior solutions operate at the application protocol level, they require specially written applications on both the device and on the connecting network peer. Therefore, extra work needed to write mobile server applications that conform to these protocols. This also makes it difficult to standardize mobile services, because the client and server applications must both include these adaptations. Therefore, it is desirable to provide IP services on mobile devices without relying on specialized applications.

### SUMMARY OF THE INVENTION

The present disclosure relates to providing network services from devices that may not be able to receive connection requests from primary network paths. In accordance with one embodiment of the invention, a method establishes a data connection between a client and a server via a primary network path, wherein the client is unable to establish the data connection to the server using established procedures of the primary network path. The method involves forming a connection request message that substitutes for a connection request of the primary network path. The connection request message is sent from the client to the server via a secondary data path that is separate from the primary network path. The data connection between the server and the client is established via the primary network path based on the connection request received at the server via the secondary data path.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 is a block diagram illustrating a network environment in which various embodiments of the invention may be practiced;

FIG. 2 is a block diagram illustrating a more particular network environment in which various embodiments of the invention may be practiced;

FIG. 3 is a sequence diagram illustrating a direct client-server connection according to embodiments of the present invention;

FIG. 4 is a sequence diagram illustrating a client-server connection via an out-of-band capable router according to embodiments of the present invention;

FIG. 5 is a block diagram illustrating a mobile terminal according to embodiments of the present invention;

FIG. 6 is a block diagram illustrating a client/router according to embodiments of the present invention;

FIG. 7A is a flowchart illustrating a procedure used by a client protocol stack for connecting to a server using an out-of-band (OOB) network path according to embodiments of the present invention;

FIG. 7B is a flowchart illustrating a procedure used by a virtual adapter of a client network protocol stack for processing OOB connection requests via SMS according to embodiments of the present invention; and

FIG. 8 is a flowchart illustrating a procedure used by a server network protocol stack for receiving connections via an OOB network path according to embodiments of the present invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present disclosure is directed to providing network services on network setups that prevent connection requests from being targeted for server devices. In one scenario, a client device includes a modified network protocol stack that recognizes a connection request targeted for a server that may not be able to receive packets used to establish a network connection. The client device forms a connection message that is equivalent to a request packet. The client sends the connection message to the server via a secondary data path that is separate from the primary path used to carry network connections. The server receives this connection message and uses it to establish a connection using the steps normally associated with typical network connection setup.

Various embodiments of the invention are described herein using examples of TCP/IP networks and TCP/IP protocol stacks. It will be appreciated, however, that the concepts may be equally applicable to other digital network connections, including other packet-switched or non-packet switched data transfer protocols. Similarly, the invention may be useful for connection-oriented protocols such as TCP/IP, but the invention may also be practiced to provide services using connectionless protocols such as UDP/IP.

A secondary or “out-of-band” network path is used to communicate the initial connection message, such as a SYN packet used to initiate a TCP/IP connection. The out-of-band (OOB) path may include any data communication path that is logically and/or physically separate from the standard communications path. Some possible secondary data paths include SMS, SIP, PTT, peer-to-peer radio links, circuit-switched data transfer/signaling, proximity wireless networking (e.g., Bluetooth, IRDA, wireless-USB), etc.

The OOB path may be used where the standard communications path prevents servers from accepting network requests. For example, some network elements (e.g., gateways, routers, firewalls) may block SYN packets used in incoming connection requests. In another example, the server may not yet have been assigned an IP address on the local network, thus is incapable of receiving any TCP/IP packets. In these and similar cases, data sent via the OOB path can signal to the server device that a connection is requested, and the server can perform the needed steps to initialize its network interfaces and/or break through intermediary network elements that may be blocking incoming packets.

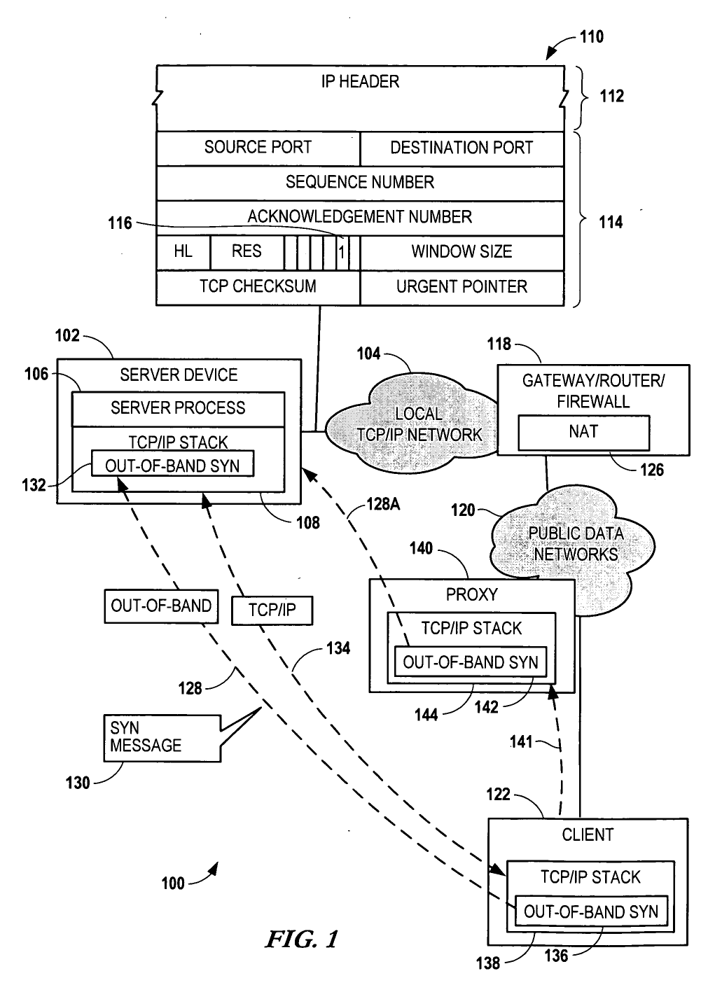

Referring now to FIG. 1, a network environment 100 is illustrated in which various embodiments of the invention may be practiced. A server device 102 is coupled to a local TCP/IP network 104. The server device 102 may be any data processing arrangement, including a mobile wireless device such a cellular phone, Personal Digital Assistant (PDA), and laptop/notebook computer. The local TCP/IP network 104 may provide TCP/IP connections using any data transmission medium and physical layer protocols known in the art. For example, the network may provide TCP/IP connections over any combination of Ethernet, 802.11 Wireless, General Packet Radio Service (GPRS), Universal Mobile Telecommunication System (UMTS), WiMax, Ultra-WideBand (UWB), etc.

The server device 102 contains a server process 106 that listens for incoming connections via a TCP/IP stack 108. The server process 106 may be any be configured to handle any type of standard or proprietary data communications, including HTTP, SMTP, File Transfer Protocol (FTP), peer-to-peer data transfer protocols, instant messaging (IM), etc. The server process 106 relies on the TCP/IP stack 108 to listen for incoming connections. The server process 106 typically makes a procedure call to standard system libraries in order to establish a TCP/IP listener. For example, a server process 106 that is written in the Java™ programming language may instantiate an object that inherits from the ServerSocket class. The object defines a port (and address if the server 102 has more than one IP interface) on which to listen, and calls the “ServerSocket::accept” method. The “accept” method causes the object (via the TCP/IP stack 108) to listen for incoming connections on the predefined port and address of the server device 102.

The TCP/IP stack 108 handles the particulars of accepting TCP/IP connection requests on behalf of the server process 106. When a client wishes to establish a TCP/IP connection to the server 102, a special IP packet, described herein as a SYN packet 110, is sent to the server device 102 to initiate a three-way TCP/IP connection handshake. The SYN packet 110 is an IP datagram containing an IP header 112 and a specially formed TCP header 114. A particular bit in the TCP header 114, known as the SYN flag 116, is set to 1, therefore signifying that this is the initial packet in a connection request. Particulars of the connection request (e.g., source and destination ports, sequence number, etc.) are contained in other parts of the TCP header 114, and in the IP header 112 (e.g., source and destination addresses).

Often, local networks 104 are separated from external, public networks 120 via a gateway/router/firewall 118 device (hereinafter referred to as a gateway 118). The gateway 118 may be configured to block incoming SYN packets 110 originating from the public networks 120. If so, then even if the server device 102 has a routable IP address that is known by a client device 122, the gateway 118 may prevent the client 122 from connecting to the server 102 by blocking SYN packets 110 used to initiate such connections.

Even where the gateway 118 does not block incoming SYN packets, the server device 102 may not be directly reachable by the client device 122 via the gateway 118. For example, local networks 104 commonly utilize non-Internet-routable IP addresses. These non-routable IP address spaces have been reserved for private networks by the Internet Assigned Numbers Authority (IANA), and are defined in RFC 1918. One example of these non-routable addresses includes addresses in the range of 10.0.0.0 to 10.255.255.255. Devices on the local network 104 are assigned these non-routable addresses by a local network authority (e.g., a Dynamic Host Configuration Protocol server) and access to the public networks 120 is provide by the gateway 118 using Network Address Translation (NAT) 126.

A NAT gateway 118 has at least two IP addresses: one belonging to the address space of the local network 104, and one or more addresses belonging to an external network, here the public data network 120. The NAT gateway 118 is set up as the default, external gateway for the local network 104. Outbound packets originating from the local network 104 are received at the NAT gateway 118, which replaces the source address of the local device (e.g., server 102) with an external address of the NAT gateway 118. The NAT gateway 118 may use different schemes for mapping between private and public addresses. Where the NAT gateway 118 has only a single external IP address, the gateway 118 may remap source ports associated with the outbound packets to differentiate between connections maintained by different hosts on the local network 104.

If the NAT gateway 118 does not use a static, one-to-one mapping between private and public addresses, then the gateway 118 may not be able to target incoming connection requests to a particular host on the local network 104. For example, assume a NAT gateway 118 has a single public IP address of 213.18.123.100 that services ten hosts mapped to a 10.0.0.0 address space on the local network 104. If the NAT receives an incoming packet at 213.18.123.100:80 (i.e., port 80, the well-known HTTP port), the gateway 118 cannot tell which (if any) of the local hosts is the destination for the incoming packet (also assuming the gateway 118 itself does not respond to port 80).

Despite this problem, servers 102 can be operated behind a NAT gateway 118. Typically, this is done by preconfiguring the NAT gateway 118 to route all incoming traffic having a particular destination port to a particular host. For example, all requests at port 80 may be directed to 10.0.0.8, which is the local IP address of a Web server on the network 104. However, such preconfigurations are generally not useful in a local network 104 populated by mobile devices 102. Mobile devices 102, by their very nature, are designed to freely enter and exit the local network 104. Therefore, a predetermined mapping of ports to destination hosts would be inflexible and unreliable. Also, this would not allow multiple hosts on the local network 104 to use the same port for network services.

A further complication in providing services on the local network 104 is that the mobile device 102 may not even attempt to join the local network 104 until there is a request by an application running on the device 102 for an outbound data connection. By waiting to join the local network 104, the device 102 can conserve power and reduce contention for limited network resources. Similarly, even after joining the network 104, the device may later release the IP address and remove itself from the network 104 to save power and/or resources. In such a case, the NAT gateway 118 cannot reliably map the device's address to a particular TCP/IP request, because at any given time the device 102 may not be addressable.

Therefore, in order for a local device 102 to provide services on a local network 104, the device 102 may not be able to rely on a typical NAT gateway 118 to receive incoming connection requests. Instead, the illustrated local device 102 is adapted to receive connections via an out-of-band pathway 128. A client device 122 (or some intermediary acting on behalf of the client 122) may be enabled to send a SYN message 130 via the out-of-band pathway. The SYN message 130 may contain most or all of the data contained in the SYN packet 110, although not necessarily in the same order and/or format.

The TCP/IP stack 108 of the server device 102 may be configured with an out-of-band SYN module 132 that is able to receive the SYN message 130 via a network path that is separate from the primary network connection path. As represented in FIG. 1, a TCP/IP connection 134 is the primary network path, and typically runs through the NAT firewall 118. The out-of-band SYN module 132 may utilize a hardware interface separate from the network interface used for the primary connection 134, or the module 132 may use the same hardware as the primary connection 134, but use a different logical path, protocol, and/or transfer mechanism.

Generally, in order for the client 122 to directly initiate a connection to the server device 102 via the out-of-band pathway 128, the client 122 may have its own out-of-band SYN module 136 as part of the client's TCP/IP stack 138. The client out-of-band SYN module 136 may intercept connection requests targeted for an address/hostname/URL that is known to utilize the out-of-band pathway 128. Such connection requests are intercepted at the client TCP/IP stack 138 and sent as a SYN message 130 via the out-of-band pathway 128.

In another arrangement, the client 122 may have an unmodified TCP/IP stack, yet still access the server device 102 via a proxy 140. The proxy 140 receives requests (e.g., a standard SYN packet 110) targeted for the server device 102 via the public network 120 (or other network) as represented by path 141. The proxy server 140 contains an out-of-band SYN module 142 as part of a modified TCP/IP stack 144. The proxy 140 initiates the connection to the server 102 on behalf of the client 122 via the out of band pathway 128A, and thereafter facilitates the TCP/IP connection 134 between the client 122 and server 102.

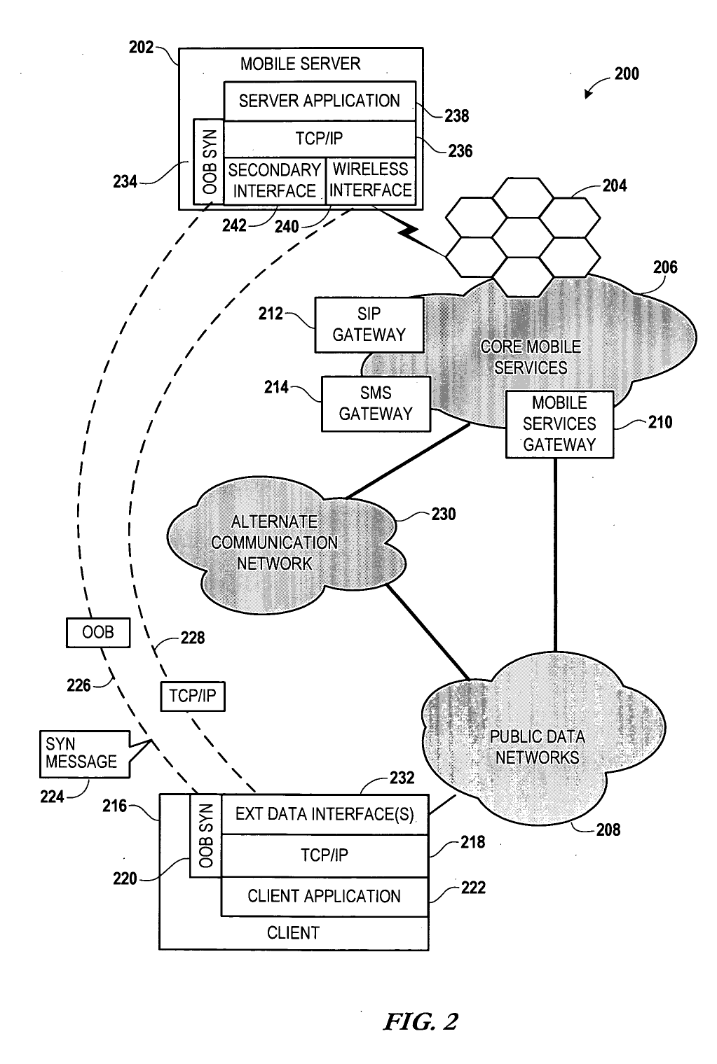

The system described in relation to FIG. 1 may be implemented in all manner of communications networks using a wide variety of devices. A more particular example of a server implemented in a mobile communications network according to an embodiment of the invention is shown in FIG. 2. The system shown in FIG. 2 is implemented in cellular data communications environment 200. For example, the environment 200 may include a GSM/GPRS cellular data network. GPRS provides packet radio access for mobile GSM and time-division multiple access (TDMA) users. GPRS allows network operators to implement an IP-based core architecture for data applications. This core architecture can expanded to provide third generation (3G) integrated voice and data applications to users of a GPRS enabled mobile server 202. It will be appreciated, however, that the invention may be applicable to any form of mobile data communications network, including alternate cellular systems (e.g., UTMS) or other wireless data communications systems.

The server 202, commonly referred to as a terminal, mobile station (MS) and/or user equipment (UE), is capable of connecting to the network environment 200 via a radio access network 204. The radio network 204 may be able to provide both packet-switched and circuit switched data services to the server 202. The circuit-switched data service allows the terminal 202 to make standard telephone calls such as via the public switched telephone network (PSTN). Packet-switched data services provide standard digital data traffic such as Web browsing and email. The packet-switched data services are provided to the server 202 via a core mobile services network 206 that is generally the domain of the wireless services provider. The mobile service network 206 can be coupled to a public data network 208 (e.g., the Internet) to provide mobile devices access to the public networks 208.

Besides providing general-purpose packet switched data services, the core network 206 may be able to provide data services that are specialized for mobile devices. For example, the core network may provide text messaging, teleconferencing, Push-to-Talk, etc. These specialized data services may be used as secondary data paths used for initiating TCP/IP data connections with the mobile server 202. The specialized data services may be contained entirely within the mobile services network 206, although such services may have interfaces accessible by the public networks 208, as represented by the generic mobile services gateway 210. More particular examples of gateway nodes include a Session Initiation Protocol (SIP) gateway 212 and a Short Messaging Service (SMS) gateway 214.

The SIP gateway 212 may be used to link Internet based applications with multimedia services available on the mobile network 202. Generally, SIP is a signaling protocol for providing digital devices with call processing functions similar to those provided by the PSTN. SIP is an important component in such technologies as Voice Over IP (VoIP), Push-to-Talk (PTT), Instant Messaging (IM), Internet conferencing, etc. SIP is an HTTP-like protocol, and thus is very easily utilized within both mobile networks 206 and public networks 208.

The SMS gateway 214 provides an interface between Internet-based applications and custom or proprietary SMS protocols used on the mobile services network 206. The SMS gateway 214 allows the translation and exchange of text messages between Internet hosts and mobile users. The SMS gateway 214 may utilize any combination of mobile protocols such as GSM-SMS and Wireless Access Protocol (WAP) for providing SMS and related services to a wide variety of mobile terminals.

In the illustrated environment 200, client device 216 may be specially adapted to initiate data connections with the mobile server 202. The client device 216 may include a specially adapted TCP/IP stack 218 that works with an out-of-band SYN module 220. The TCP/IP stack 218 and out-of-band SYN module 220 detect connection requests targeted for a mobile server 202. These connection requests may originate from a standard, unmodified client application 222, and may be detected as targeted for the server based on a destination address or other network data. The connection is initiated by the out-of-band SYN module 220, which sends a SYN message 224 via a secondary data path 226 in order to establish a primary data connection, such as a TCP/IP connection 228.

The secondary data path 226 and TCP/IP connection 228 may both utilize portions of the public and mobile networks 208, 206, as well as any gateway nodes (e.g., 210, 212, 214) associated with those networks 208, 206. The secondary data path 226 may also utilize alternate communication networks 230 for at least sending the SYN message 224 to the server 202. Generally, the alternate communications networks 230 may include low-bandwidth, one-way communications paths that may not be suitable for establishing a full duplex connection. For example, the SYN message 224 may be sent by radio broadcast, either from line-of-site or satellite sources. Generally, the client device 216 contains one or more external data interfaces 232 capable of communication over the secondary data path 226 and/or TCP/IP connection path 228.

The mobile server 202 generally contains an out-of band module 234 that operates with a server TCP/IP stack 236 for establishing the TCP/IP connection 228 using the incoming SYN message 224. The established connection 228 can be used by an unmodified (e.g., unaware of the OOB mechanisms) server application 238 for providing network services. The TCP/IP connection 228 is typically communicated over a primary wireless network interface 240 of the server device, although a secondary interface 242 (wired or wireless) may be used for this purpose. The incoming SYN message 224 may also be communicated via either interface 240, 242.

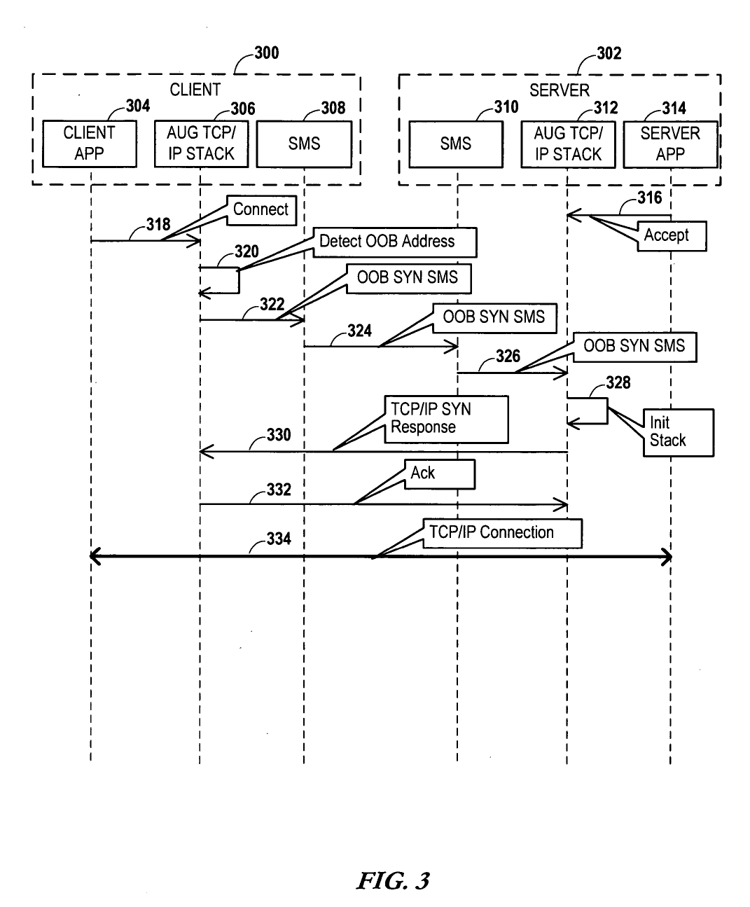

A more detailed example of an out-of-band SYN connection according to an embodiment of the present invention is illustrated in FIG. 3. FIG. 3 is a sequence diagram illustrating a TCP/IP connection between a client 300 and server 302 using an out-of-band SYN message over SMS. The client 300 includes a client application 304, which could be a program, OS service, or any other functional module. The client 300 also includes an augmented TCP/IP stack 306 having the capability to direct out of band SYN requests, such as via an SMS module 308.

The server 302 also includes an SMS module 310 and augmented TCP/IP stack 312 that are compatible with the client's SMS module 308 and augmented TCP/IP stack 306. A server application 314 runs on the server 302, and, like the client application 304, has no special adaptations for dealing with out-of band connections. Therefore, the server application 304 merely makes a standard “accept” function call 316 (or similar instructions known in the art) to the augmented TCP/IP stack 312. The augmented TCP/IP stack 312 is thereafter prepared to accept incoming SYN messages via the SMS module 310.

The client application 304 makes a connection request 318 to the client's augmented TCP/IP stack 306. The request 318 will at least contain an address and port of the destination server 302. The address and port may be in any form, including a hostname, IP address, port number, URL, etc. For example, a connection request containing the URL “http://user.mobileaccess.net” includes both a port and hostname, because the “http” indicates that the connection is requested on the standard HTTP port of 80.

The augmented TCP/IP stack 306 receives the connection request 318 and detects 320 whether special provisions must be made to initiate the connection. For example, the outgoing connection request 318 may include a specially formed hostname such as “OOB17813081030.nokia.com.” This is detected 320 by the augmented TCP/IP stack 306 as the hostname of an out-of-band server 302. Further, the hostname includes a Mobile Subscriber Integrated Services Digital Network (MSISDN) number of the server 302. The MSISDN number is needed by the SMS module 308 in order to communicate with the server 302 via SMS.

Generally, the augmented TCP/IP stack 306 may include a virtual adaptor layer that replaces and/or augments the normal routing address resolution mechanisms at the TCP/IP stack 306 and/or associated network interfaces. The augmented TCP/IP stack 306 (or related services) may assign a special, short-lived pseudo destination IP address to detected out-of-band (OOB) hostnames. The pseudo address is an RFC 1918 private address that is unique to the local subnet. Other layers of the augmented TCP/IP stack 306 may recognize such out-of-band pseudo destination addresses and apply special processing to them. In particular, the augmented TCP/IP stack 306 forms an OOB SYN message 322, which is then sent to the SMS module 308.

Besides assigning a pseudo address to the outgoing connection, augmented TCP/IP stack 306 may also determine the MSISDN of the destination server 302. The MSISDN may be parsed out of the hostname, or the augmented TCP/IP stack 306 may used an internal or external lookup similar to a Domain Name Service (DNS) address resolution. The augmented TCP/IP stack 306 sends the MSISDN to the SMS module with the OOB SYN message 322. The SMS module 308 uses the MSISDN for connecting to the server 302 via the SMS communication channels of the mobile network for purposes of sending an outgoing OOB SYN message 324.

Upon receipt of the OOB SYN message 324, the server's SMS module 310 passes the OOB SYN 326 to a virtual adapter layer of the server's augmented TCP/IP stack 312. The augmented TCP/IP stack 312 may perform certain initialization actions 328. For example, the augmented TCP/IP stack 312, if it hasn't done so already, may obtain an IP address via DHCP. As part of initialization, the augmented TCP/IP stack 312 may construct a standard TCP/IP SYN packet based on the contents of the received OOB SYN message 326 and inject this packet into the bottom of the existing IP message stack. Thereafter, the augmented TCP/IP stack 312 sends a TCP/IP SYN response 330 that acknowledges the receipt of the OOB SYN message 326.

When the client 300 receives the TCP/IP SYN response 330, the augmented TCP/IP stack 306 can determine that the previously sent OOB SYN message 324 was received successfully, based, for example, on the TCP sequence numbers in the TCP/IP SYN response 330. A routable IP address used for accessing the server 302 will also be contained in the TCP/IP SYN response 330, and the augmented TCP/IP stack 306 can thereafter perform “reverse network address translation” using this address. For example, augmented TCP/IP stack 306 can translate between the actual peer IP address and a special OOB IP pseudo address assigned to this connection when the OOB SYN message was sent 322, 324.

The client's augmented TCP/IP stack 306 then sends an acknowledgement packet 332 to the server 302 to complete the three-way TCP handshake. Thereafter the client and server applications 304, 314 can communicate using an established TCP/IP connection 334. The TCP/IP connection 334 can be used and terminated as is known in the art.

The client 300 and server 302 may need to establish multiple sequential or parallel TCP/IP connections in order to perform certain transactions. For example, HTTP is a stateless protocol, so each HTTP method involves creating a new TCP/IP connection to invoke the method. Downloading a Web page may involve invoking many TCP/IP connections. Therefore, the client 300 and server 302 may use mechanisms that allow additional connections to be established without having to utilize the OOB channel. For example the client 300 and server 302 may establish a unique TCP/IP connection used solely for sending SYN messages. These SYN messages may be encapsulated in regular TCP/IP packets, so that any firewalls that block SYN packets will not detect and block connection requests. This specialized TCP/IP connection could be terminated after a predetermined period of inactivity.

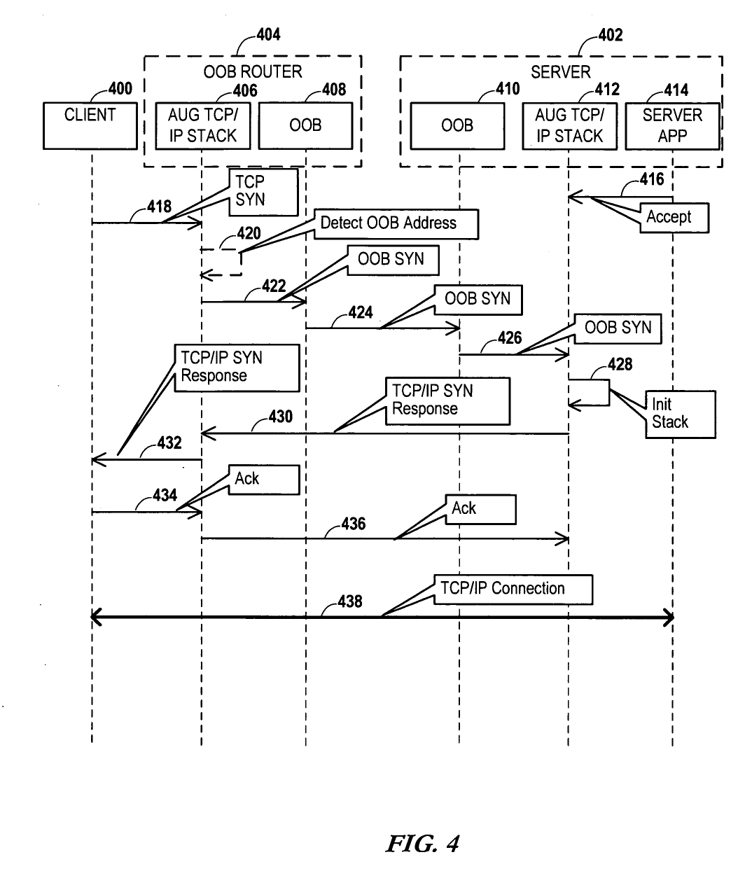

The use of a client 300 with an augmented TCP/IP stack 306 may be useful in some situations, such as when initiating connections between terminal devices that are made by the same vendor and that operate on compatible service provider networks. However, it may be desirable to allow connections to the server 302 by unmodified clients. This may be achieved using an OOB router, which is a special intermediary proxy node that assists in sending OOB SYN connections to the server. FIG. 4 shows a client/server connection sequence using an OOB router according to embodiments of the present invention.

In FIG. 4, a standard client device 400 connects to a server 402 via an OOB router 404. Generally, the OOB router 404 assists in sending initial SYN packets to the server using an OOB channel. The OOB router 404 includes an augmented TCP/IP stack 406 and one or more OOB modules 408 enabled to communicate over any type of OOB channel (e.g., SMS, SIP, etc.). The OOB router 404 may be a dedicated device that provides OOB connection services to a wide range of devices and networks, therefore the router 404 may include multiple OOB modules 408 in order to handle differences inherent in these wide-ranging devices and networks. The server 402 includes at least one compatible OOB module 410, as well as an augmented TCP/IP stack 412 and server application 414 similar to those described in relation to FIG. 3.

The procedure in FIG. 4 proceeds similarly in some respects to the procedure of FIG. 3, with the server application 414 making an accept call 416 to begin receiving connection requests. The unmodified client 400 makes a connection request using a TCP SYN packet 418 directed to the server 402. The server's address resolves to (e.g., using DNS) the address of the OOB router 404. The OOB router 404 receives the TCP SYN packet 418 and recognizes this is a request to connect to the server 402.

Because the OOB router 404 is a dedicated device, it may be safely assumed that all incoming connection requests 418 require forming OOB SYN messages. Therefore detection 420 of the OOB address may not be necessary. However, the OOB router 404 may provide connection services for a plurality of servers, therefore some resolution of request parameters may be needed to determine the identity of the destination server 402. For example, the OOB router 404 may accept connections at ports 10000 and 10001, which are internally mapped to this particular server 402 at ports.80 and 23. One or more services on different servers may be mapped to unique ports as well. Therefore, the detection 420 of the OOB address may involve a predetermined mapping of connection parameters (e.g., TCP ports) to servers.

The OOB router 404 will then form an OOB SYN message 422 which is formatted and sent to the appropriate OOB module 408. The OOB module 408 then sends the OOB SYN 424 to the OOB module of the server 402. The server 402 processes the incoming message 426 as previously described in FIG. 3, by initializing 428 the TCP/IP stack 412 and sending a response SYN 430. However, in this example, the SYN response 430 is sent to the OOB router 404, which is able to detect the actual TCP/IP address of the server 402 based on the response 430. A reformatted SYN response 432 is sent to the client 400, with the server's IP address replaced by the OOB router's IP address, similar to NAT address translation. Thereafter, traffic between the client 400 and server 402, such as the ACK 434, 436, is routed through the OOB router 404, which applies the appropriate NAT transformations. A TCP/IP connection 438 is thereafter established between the client 400 and server 402, with traffic being sent and translated via the OOB router 404.

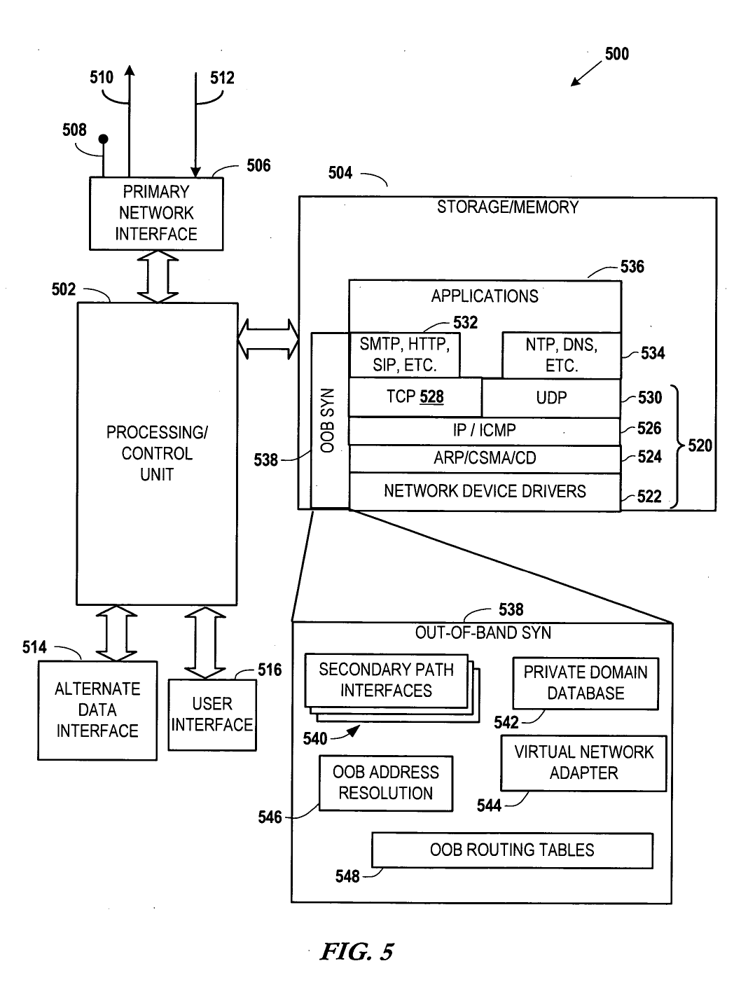

Many types of apparatuses may be configured to perform roles as both servers and clients in network environments described herein. Mobile devices may particularly benefit from OOB SYN connections, as such devices are likely to connect to many different networks on a transient, ad-hoc, basis. In FIG. 5, an example mobile computing arrangement 500 is illustrated that is capable of carrying out operations in accordance with embodiments of the invention. Those skilled in the art will appreciate that the exemplary mobile computing arrangement 500 is merely representative of general functions that may be associated with such mobile devices, and also that landline computing systems similarly include computing circuitry to perform such operations.

The illustrated mobile computing arrangement 500 may suitable for accepting incoming connections via one or more secondary data paths. The mobile computing arrangement 500 includes a processing/control unit 502, such as a microprocessor, reduced instruction set computer (RISC), or other central processing module. The processing unit 502 need not be a single device, and may include one or more processors. For example, the processing unit may include a master processor and associated slave processors coupled to communicate with the master processor.

The processing unit 502 controls the basic functions of the arrangement 500. Those functions associated may be included as instructions stored in a program storage/memory 504. In one embodiment of the invention, the program modules associated with the storage/memory 504 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 500 via data signals, such as being downloaded electronically via one or more networks, such as the Internet and an intermediate wireless network(s).

The program storage/memory 504 may also include operating systems for carrying out functions and applications associated with functions on the mobile computing arrangement 500. The program storage 504 may include one or more of read-only memory (ROM), flash ROM, programmable and/or erasable ROM, random access memory (RAM), subscriber interface module (SIM), wireless interface module (WIM), smart card, hard drive, or other removable memory device.

The mobile computing arrangement 500 includes hardware and software components coupled to the processing/control unit 502 for performing network data exchanges. The mobile computing arrangement 500 may include multiple network interfaces for maintaining any combination of wired or wireless data connections. In particular, the illustrated mobile computing arrangement 500 includes a primary network interface 506 suitable for performing wireless data exchanges via a network.

This primary network interface 506 may include a digital signal processor (DSP) employed to perform a variety of functions, including analog-to-digital (A/D) conversion, digital-to-analog (D/A) conversion, speech coding/decoding, encryption/decryption, error detection and correction, bit stream translation, filtering, etc. The primary network interface 506 may also include transceiver, generally coupled to an antenna 508, that transmits the outgoing radio signals 510 and receives the incoming radio signals 512 associated with the wireless device 500.

The mobile computing arrangement 500 may also include an alternate data interface 514 coupled to the processing/control unit 502. The alternate interface 514 may include the ability to communicate on via wired and/or wireless data transmission mediums via network and/or point-to-point data transfer protocols. The alternate interface 514 may include the ability to communicate using Bluetooth, 802.11 Wi-Fi, Ethernet, IRDA, and related networking technologies. The alternate interface 514 may include the ability to communicate using peripheral data transfer technologies such as USB, IEEE 1394 “Firewire,” PCMCIA, PCI, etc.

The processor 502 is also coupled to user-interface 516 elements associated with the mobile terminal. The user-interface 516 of the mobile terminal may include, for example, a display such as a liquid crystal display, a keypad, speaker, microphone, etc. These and other user-interface components are coupled to the processor 502 as is known in the art. Other user-interface mechanisms may be employed, such as voice commands, switches, touch pad/screen, graphical user interface using a pointing device, trackball, joystick, or any other user interface mechanism.

The storage/memory 504 of the mobile computing arrangement 500 may include software modules for providing network services via any of the network interfaces (e.g., primary and alternate interfaces 506, 514). In particular, the storage/memory 504 includes a protocol stack 520 that provides the ability to engage in network communications via one or more of the communication interfaces 506, 514. At the lowest level of the stack 520, device drivers 522 provide low-level hardware access to the network interfaces 506, 514.

Above the device drivers, a hardware access layer 524 provides mapping between hardware identifiers on the network and logical structures higher up in the protocol stack 520. For example, the Address Resolution Protocol (ARP) provides mapping between hardware Media Access Control (MAC) addresses and IP addresses for other network devices. The hardware access layer 524 may also handle network contention issues, such as provided by Carrier Sense Multiple Access/Collision Detection (CSMA/CD) protocols, which determine how network devices respond when two devices attempt to use a data channel simultaneously. Devices on Ethernet networks use CSMA/CD to monitor the traffic on the line.

At the next layer of the protocol stack is a network layer 526 that provides for end-to-end data transmission services, as typified by IP. The Internet Control Message Protocol (ICMP) is often integrated with the IP functionality, although architecturally ICMP is layered upon IP. ICMP allows hosts to report error, control, and informational messages in specially formed IP packets.

The highest layer of the illustrated protocol stack 520 is the transport layer, which is typified by TCP 528 and UDP 530 protocol segments. TCP 528 provides for reliable, connection-oriented data transfers. TCP 528 guarantees that data packets transmitted via IP are assembled in the correct sequence and provides for retransmission of lost packets. UDP 530 is unreliable, in that the UDP layer 530 does not ensure the arrival of all transmitted packets. UDP 530 is useful for such services as broadcasting or multicasting multimedia, which is tolerant of occasionally missing or out of sequence data.

The protocol stack 520 is used by application layer protocols 532, 534 and end-user application 536. These application layer protocols 532, 534 are shown separated based on whether they rely on TCP 528 or UDP 530. Common TCP/IP application protocols 532 include HTTP, Simple Mail Transfer Protocol (SMTP), and File Transfer Protocol (FTP). SIP may also be included with the TCP/IP application layer protocols 532, although strictly speaking it is considered a session layer protocol. Common UDP/IP session/application protocols 534 include Network Time Protocol (NTP) and Domain Name Service (DNS). DNS may also use TCP/IP in some instances. The application layers protocols 532, 534 can be integrated into the operating system, or provided as separate applications.

The application layers protocols 532, 534 may be a subset of the end-user applications 536. Generally, the end user applications 536 refer to any process that can be added on and/or removed independently of the operating system and/or protocol stack 520. The user applications 536 may be client or server applications. For example a Web browser is a commonly used HTTP client application. A Web server (such as Apache Web server) is an HTTP server application.

An OOB SYN module 538 augments the illustrated protocol stack 520. The OOB SYN module 538 can be used both to initiate network connections as on behalf of client applications and receive network connection requests on behalf of server applications. The OOB SYN module 538 may communicate with and/or be part of any layer of the protocol stack 520. Typically, a portion of the functionality of the OOB SYN module 538 resides with the TCP layer 528.

The OOB SYN module 538 includes one or more secondary path interfaces 540 that can be used to make outgoing OOB connections or receive incoming OOB connections for purposes of transferring SYN-equivalent messages. For example, one of the secondary path interfaces 540 may be able to communicate SYN-equivalent messages via SMS. The secondary path interfaces 540 may communicate over any combination of the primary and alternate hardware interfaces 506, 514.

The OOB SYN module may include a virtual network adapter 544 that operates below the IP layer. When the computing arrangement 500 is acting as a client, the virtual network adapter 544 assigns each outgoing OOB TCP/IP connection a special, short-lived pseudo destination IP address. This is an RFC 1918 private address that is unique to the local subnet. When the computing arrangement 500 initiates a connection, the virtual adapter 544 recognizes such OOB pseudo destination addresses and applies special processing to them. In particular the virtual network adapter 544 routes outgoing TCP/IP SYN packets for these addresses via the OOB channel (e.g., using one of the secondary path interfaces 540). This replaces the normal routing address resolution step at the network interface).

For all other packets associated with an OOB-initiated connection, the virtual network adapter 544 performs reverse network address translation, translating between the actual peer IP address and the special OOB IP pseudo address assigned to the connection. When the computing arrangement 500 is acting as a server, the virtual adapter 544 constructs standard TCP/IP SYN packets from the contents of received OOB SYN messages and injects them into the bottom of the existing IP stack.

In order for the virtual network adapter 544 to automatically apply reverse address translation, a special “OOB gateway” IP address may defined. This may be an RFC 1918 private IP address that is unique to the local subnet. On the initiating machine, an OOB routing table 548 is established that maps all OOB IP pseudo destination addresses to this OOB gateway address. The virtual network adapter 544 recognizes the OOB gateway address during address resolution and invokes the special OOB routing logic.

The virtual network adapter 544 may be capable of recognizing a destination URL as belonging to a domain that requires OOB connection mechanisms. This recognition may trigger the virtual network adapter 544 to apply special OOB processing to the outbound connection request. A private domain database 542 may provide the logic needed to recognize these special domain addresses. The private domain database 542 may include local stored or cached addresses of private domains, and may also include an interface to obtains such information by querying authoritative network entities, similar to DNS.

Another function that may be required of the OOB SYN module 538 is to determine an identifier that may be used to contact the user via the OOB channel. This is represented by the OOB address resolution module 546. This module 546 may work in conjunction with the other functional modules 544, 542, and 540 to determine an identifier used to establish the OOB connection, and use that identifier to send the initial SYN message via one of the secondary path interfaces 540. For example, where the destination address includes an MSISDN embedded in a URL, the OOB address resolution module 546 may obtain the MSISDN from URL (either directly or through the domain database 542), and use the MSISDN to send the SYN message via an SMS interface selected from the secondary path interfaces 540.

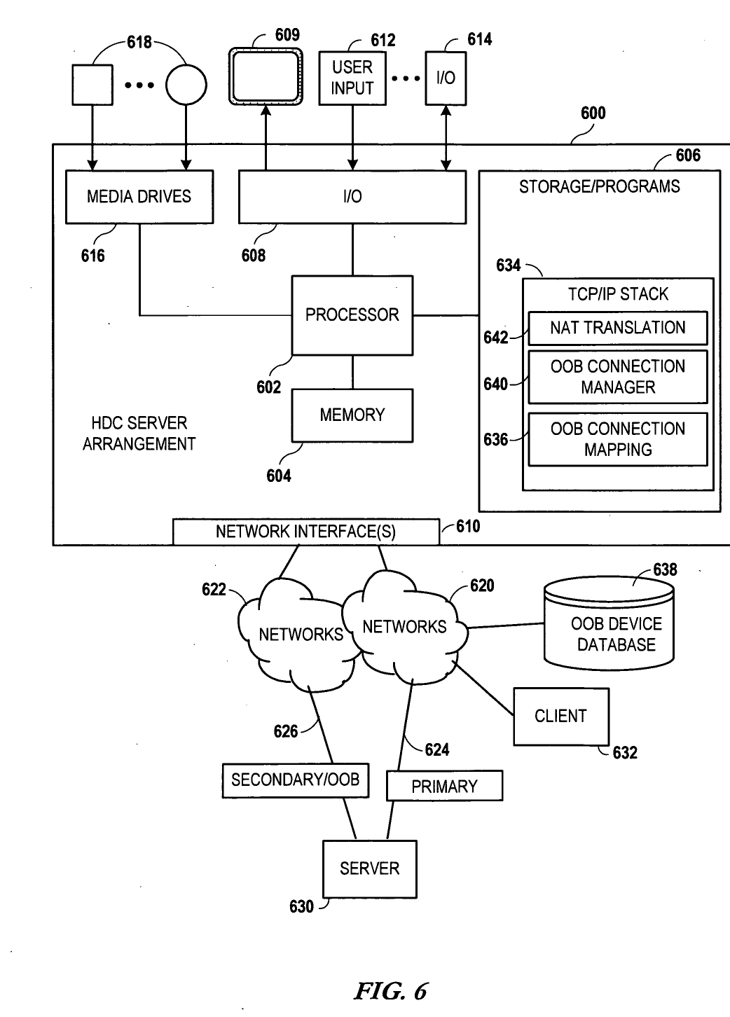

Referring back to FIG. 4, an intermediary device (e.g., OOB router 404) may provide access on behalf of an unmodified client to access services of the computing arrangement 500. In reference now to FIG. 6, a block diagram shows a representative computing implementation of an OOB router 600 capable of carrying out operations in accordance with the invention.

The OOB router 600 includes a central processor 602, which may be coupled to memory 604 and data storage 606. The processor 602 carries out a variety of standard computing functions as is known in the art, as dictated by software and/or firmware instructions. The storage 606 may represent firmware, random access memory (RAM), hard-drive storage, etc. The storage 606 may also represent other types of storage media to store programs, such as programmable ROM (PROM), erasable PROM (EPROM), etc.

The processor 602 may communicate with other internal and external components through input/output (I/O) circuitry 608. The OOB router 600 may therefore be coupled to a display 609, which may be any type of display or presentation screen such as LCD displays, plasma display, cathode ray tubes (CRT), etc. A user input interface 612 is provided, including one or more user interface mechanisms such as a mouse, keyboard, microphone, touch pad, touch screen, voice-recognition system, etc. Any other I/O devices 614 may be coupled to the OOB router 600 as well.

The OOB router 600 may also include one or more media drive devices 616, including hard and floppy disk drives, CD-ROM drives, DVD drives, and other hardware capable of reading and/or storing information. In one embodiment, software for carrying out the data insertion operations in accordance with the present invention may be stored and distributed on CD-ROM, diskette or other form of media capable of portably storing information, as represented by media devices 618. These storage media may be inserted into, and read by, the media drive devices 616. Such software may also be transmitted to the OOB router 600 via data signals, such as being downloaded electronically via one or more network interfaces 610.

The OOB router 600 may be coupled one or more computing networks 620, 622 via the network interface 610. The networks 620, 622 generally represent at least different logical networks, and may share some or all physical hardware. The networks 620, 622 provide respective primary and secondary/OOB data connection paths 624, 626 for accessing a server device 630. The server 630 operates in a network environment where it may not be able to receive connection requests via the primary data path 624. Therefore, the OOB router 600 initiates such connection requests using the secondary/OOB path 626 for the benefit of a standard, unmodified network client 632.

Generally, the data storage 606 of the OOB router 600 contains an augmented TCP/IP stack 634 for providing connection services for clients 632 and servers 630. The TCP/IP stack 634 can accept incoming connection requests (e.g., SYN packets) from the client 632 via the network interfaces 610. The TCP/IP stack 634 may be configured to determine the destination server 630 based on data contained in the SYN packet, such as a TCP port. The determination of the destination server 630 may be performed by an OOB connection mapping module 636, which determines particulars of the destination server 630, including OOB channels used to connect to the server 630, and identifiers used to contact the server 630 via those OOB channels. The connection mapping module 636 may used locally stored mapping data, or may access an external database 638 that contains the relevant OOB server information.

The initiation and sending of SYN-equivalent messages via the secondary/OOB channel 626 is handled by an OOB connection manager module 640. This module 640 deals with data formats and states of the OOB connections 626. The OOB connection manager module 640 may be responsible for determining correct SYN message formats, initiating connections, dealing with timeouts/rejections, etc. The OOB connection manager module 640 may also maintain its own primary data connections with the server 630 after a first connection has been established. These data connections can be used to instantiate further primary connections on behalf of the same or other client devices 632 without having to use the secondary/OOB channel 626.

Assuming a successful connection is established using OOB SYN, the OOB router 600 may continue to act as a NAT gateway between the client 632 and server 630. This is handled by a NAT module 642, which may remap both port and IP address information on TCP/IP packets exchanged between the client 632 and server 630.

The OOB router 600 of FIG. 6 is provided as a representative example of computing environments in which the principles of the present invention may be applied. From the description provided herein, those skilled in the art will appreciate that the present invention is equally applicable in a variety of other currently known and future mobile and landline computing environments. Thus, the present invention is applicable in any known computing structure where data may be communicated via a network.

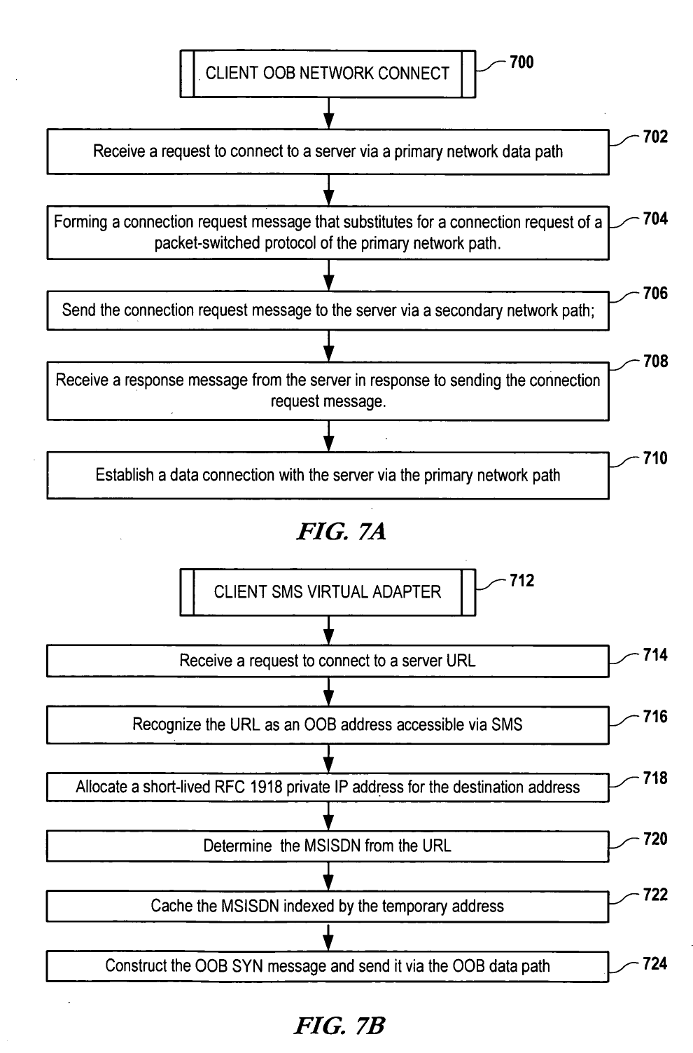

Turning now to FIG. 7A, a flowchart illustrates a general procedure 700 used by a client network protocol stack for connecting to a server using an OOB network path according to embodiments of the present invention. First, the network protocol stack receives (702) a request to connect to a server via a primary network path, such as a TCP/IP connection request. The protocol stack forms (704) a request message that substitutes for a connection request of a packet-switched protocol of the primary network path.

The network protocol stack the sends (706) the connection request message to the server via a secondary data path. In response to sending the message, a response is received (708) from the server. Thereafter, a data connection is established (710) between the client and server.

In FIG. 7B, a flowchart illustrates a procedure 712 used by a virtual adapter of a client network protocol stack for processing OOB connection requests via SMS according to embodiments of the present invention. First, the virtual adapter receives (714) a request to connect to a server URL. This URL is recognized (716) as an address accessible OOB via SMS. A short-lived, RFC 1918 private address is allocated (718) as the destination address for the connection. The MSISDN of the server is determined (720) based on the URL, and MSIDSN is cached (722) and indexed by the temporary address. The SYN message is then sent (724) via the OOB network path.

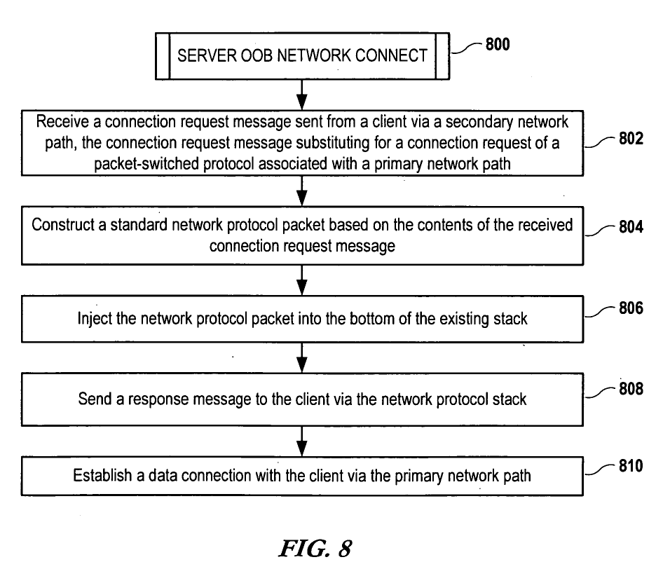

In reference now to FIG. 8, a flowchart illustrates a general procedure 800 used by a server network protocol stack for receiving connections via an OOB network path according to embodiments of the present invention. A connection request message is received (802) from a client via a secondary data path. The connection request message substitutes for a connection request of a packet-switched protocol associated with a primary network path. A standard network protocol packet is constructed (804) based on the contents of the received connection request message. The network protocol packet is injected (806) into the bottom of the existing stack. A response message is sent (808) to the client via the network protocol stack, and a data connection is then established (810) with the client via the primary network path.

Hardware, firmware, software or a combination thereof may be used to perform the various functions and operations described herein. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a system, apparatus, and method in accordance with the present invention.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

What is claimed is:

1. A method of establishing a data connection between a client and a server via a primary network path, wherein the client is unable to establish the data connection to the server using established procedures of the primary network path, the method comprising:
forming a connection request message that substitutes for a connection request of the primary network path;
sending the connection request message from the client to the server via a secondary data path that is separate from the primary network path; and
establishing the data connection between the server and the client via the primary network path based on the connection request received at the server via the secondary data path.

2. The method of claim 1, further comprising sending a response message containing a routable network address of the server in response to the connection request, and wherein the data connection between the server and the client is established using the routable network address of the server.

3. The method of claim 1, wherein the connection request is formed and sent via an augmented protocol stack of the client configured to communicate over the primary network path, and the connection request is received via an augmented protocol stack of the server configured to communicate over the primary network path.

4. The method of claim 3, wherein the data connection is established between the respective augmented protocol stacks of the server and the client.

5. The method of claim 1, wherein sending the connection request message to the server via the secondary data path comprises sending the connection request message to the server network protocol stack via a wireless instant messaging path.

6. The method of claim 5, wherein sending the connection request message to the server via the wireless instant messaging path comprises wherein sending the connection request message to the server via a Short Messaging System (SMS) path.

7. The method of claim 6, wherein forming the connection request message comprises determining a Mobile Subscriber Integrated Services Digital Network (MSISDN) number of the server, and wherein sending the connection request message to the server via the secondary data path comprises sending the connection request message via SMS using the MSISDN.

8. The method of claim 1, wherein sending the connection request message to the server via the secondary data path comprises sending the connection request message to the server via a Session Initiation Protocol (SIP) path.

9. The method of claim 1, wherein forming the connection request message comprises forming the connection request message with a destination address that is targeted for an RFC 1918 private address space.

10. The method of claim 9, wherein sending the connection request message to the server via the secondary data path comprises sending the connection request message via the secondary data path if the client detects that the destination address is targeted for the RFC 1918 private address space.

11. The method of claim 9, further comprising performing a reverse address translation at the client for packets sent subsequent to the connection request message, the reverse address translation comprising substituting the destination address with an Internet Protocol (IP) routable address of the server.

12. The method of claim 1, wherein the primary network path utilizes Transmission Control Protocol/Internet Protocol (TCP/IP), and wherein the connection request of the primary network path comprises a SYN connection request packet.

13. The method of claim 1, establishing the data connection between the server and the client via the primary network path comprises establishing the data connection through a Network Address Translation (NAT) firewall.

14. The method of claim 1, wherein the data connection comprises a first data connection, the method further comprising:
establishing a second data connection between the server and the client via the primary network path after the first data connection has been established; and
directing connection request messages from the client to the server via the second data connection for the purposes of establishing subsequent data connections via the primary network path.

15. The method of claim 14, further comprising maintaining the second data connection even if the first data connection is disconnected.

16. A data-processing arrangement, comprising:
one or more data interfaces capable of communicating with clients via a primary network path and a secondary data paths, wherein at least one of the clients is unable to establish a data connection to the data-processing arrangement using established procedures of the primary network path;
a processor coupled to the network interface; and
a memory coupled to the processor, the memory having an augmented protocol stack configured to communicate via the primary data path, the augmented protocol stack having instructions that cause the processor to,
receive a connection request message sent from the at least one client via the secondary data path, the connection request message substituting for a connection request associated with the primary network path; and
establish the data connection with the client via the primary network path based on receipt of the connection request message via the secondary data path.

17. The data-processing arrangement of claim 16, wherein the memory has instructions that further cause the processor to send a response message containing a routable network address of the data-processing arrangement in response to the connection request, and wherein the data connection with the client is established using the routable network address of the data-processing arrangement.

18. The data-processing arrangement of claim 16, wherein the one or more network interfaces comprises a cellular communications interface.

19. The data-processing arrangement of claim 18, wherein the secondary data path comprises a Short Message Server (SMS) data path.

20. The data-processing arrangement of claim 16, wherein the secondary data path comprises a Session Initiation Protocol (SIP) data path.

21. The data-processing arrangement of claim 16, wherein the primary network path comprises a Transmission Control Protocol/Internet Protocol (TCP/IP) network path.

22. The data-processing arrangement of claim 21, wherein the connection request associated with the primary network path comprises a TCP/IP SYN connection request packet.

23. The data-processing arrangement of claim 16, wherein the data-processing arrangement comprises a mobile terminal.

24. A processor-readable medium having instructions of an augmented protocol stack stored thereon which are executable by a data-processing arrangement capable of being coupled via a primary network path and a secondary data path to one or more clients, wherein at least one of the clients is unable to establish a data connection to the data-processing arrangement using established procedures of the primary network path, the instructions executable by the data processing arrangement for performing steps comprising:
receiving a connection request message sent from the at least one client via the secondary data path, the connection request message substituting for a connection request associated with the primary network path; and
establishing a data connection with the client network via the primary network path based on receipt of the connection request message.

25. A data-processing arrangement, comprising:
a one or more data interfaces capable of communicating with a server via a primary network path and a secondary data path;
a processor coupled to the network interface; and
a memory coupled to the processor, the memory having an augmented protocol stack configured to communicate via the primary data path, the augmented protocol stack having instructions that cause the processor to,
determine that the data processing arrangement is unable to establish a data connection to the server using established procedures of the primary network path;
send a connection request message that substitutes for a connection request of the primary network path to the server via the secondary data path;
receive a response message from the server in response to the connection request message; and
establish a data connection with the server via the primary network path in response to receiving the response message.

26. The data-processing arrangement of claim 25, wherein the response message includes a routable network address of the server, and wherein the data connection with the server is established using the routable network address of the server.

27. The data-processing arrangement of claim 25, wherein the one or more network interfaces comprises a cellular communications interface.

28. The data-processing arrangement of claim 27, wherein the secondary data path comprises a Short Message Server (SMS) data path.

29. The data-processing arrangement of claim 28, wherein the instructions further cause the processor to:
receive a request to connect to the server, the request including a Mobile Subscriber Integrated Services Digital Network (MSISDN) number of the server; and
wherein sending the connection request message to the server via the secondary data path comprises sending the connection request message via SMS using the MSISDN.

30. The data-processing arrangement of claim 25, wherein the secondary data path comprises a Session Initiation Protocol (SIP) data path.

31. The data-processing arrangement of claim 25, wherein the network protocol stack comprises a Transmission Control Protocol/Internet Protocol (TCP/IP) stack.

32. The data-processing arrangement of claim 31, wherein the connection request of the packet switched network comprises a TCP/IP SYN connection request packet.

33. The data-processing arrangement of claim 25, wherein the augmented protocol stack further causes the processor to receive via the one or more network interfaces a client request to connect to the server via the primary network path, and wherein the connection request message is formed on behalf of a client in response to the client request, and wherein establishing the data connection with the server via the primary network path comprises establishing the data connection between the server and the client on behalf of the client.

34. A processor-readable medium having instructions of an augmented protocol stack stored thereon which are executable by a data-processing arrangement capable of being coupled to a server via a primary network path and a secondary data path, the instructions executable by the data processing arrangement for performing steps comprising:
determining that the augmented protocol stack is unable to establish a data connection to the server using established procedures of the primary network path;
forming a connection request message that substitutes for a connection request of a packet-switched protocol of the primary network path;
sending the connection request message to a server via the secondary data path;
receiving a response message from the server in response to sending the connection request message; and
establishing a data connection with the server via the primary network path in response to receipt of the response message.

35. A system comprising:
means forming a connection request message at a client, the connection request message substituting for a connection request of a packet-switched protocol of a primary network path;
means for sending the connection request message to a server via a secondary data path that is separate from the primary network path;
means for establishing the data connection between the server and the client via the primary network path based on receipt of the connection request message.
